(19) United States
(12) Patent Application Publication
(10) Pub. No.: US 2026/0327976 A1
(43) Pub. Date: Oct. 22, 2026

(54) PARTITION

(71) Applicant: OKAMURA CORPORATION, Kanagawa (JP)

(72) Inventors: Riho HIROSE, Kanagawa (JP); Waku TSUCHIYAMA, Kanagawa (JP); Tsuneo SHIMOMURA, Kanagawa (JP); Kazuki TAKANO, Kanagawa (JP)

(21) Appl. No.: 19/108,679

(22) PCT Filed: Aug. 29, 2023
(86) PCT No.: PCT/JP2023/031143

§ 371 Date: Mar. 4, 2025

(30) Foreign Application Priority Data
Sep. 5, 2022 (JP) 2022-140588

(51) Int. Cl. E04B 2/74; E05D 15/06

(52) U.S. Cl. CPC E04B 2/74; E05D 15/06

(57) ABSTRACT

A partition that smoothly shifts in direction and also has a favorable straight-running property is provided. A partition includes a pair of guide portions that are guided along a guide rail in an upper end portion of the partition, and a wheel configured for running on a floor surface in a center part of a lower end portion of the partition.

### TECHNICAL FIELD

The present invention relates to a partition, for example, a partition whose upper end portion is guided movably along a guide rail.

### BACKGROUND ART

As a partition that partitions a space, the partition whose upper end portion is movable along a guide rail, for example, there is a moving partition device as described in Patent Citation 1. In this moving partition device, it is possible to partition an interior space with a plurality of partitions by supporting upper end portions of the plurality of partitions by a guide rail built on a ceiling so as to be orthogonal to opposing wall surfaces of a room via a pair of rollers, and by making pairs of left and right casters provided in lower end portions of the partitions run along a floor surface. Also, it is possible to make the plurality of partitions shift in direction at right angles one by one and house in a housing guide rail built on the wall surface side so as to continuously cross the guide rail, the housing guide rail being formed in a U shape in a plan view.

### CITATION LIST

### Patent Literature

Patent Citation 1: JP 7001467 B (FIG. 1, Page 4)

### SUMMARY OF INVENTION

### Technical Problem

In the partition described in Patent Citation 1, the pair of casters are provided in the lower end portion. Thus, it is possible to smoothly perform a direction shift from the housing guide rail to the guide rail side, or the other way around. However, the caters are rotated freely around their vertical axes. Thus, there is a problem that a straight-running property is poor when the plurality of partitions are continuously connected in a linear form along the guide rail.

The present invention has been made in view of such a problem and an object of the present invention is to provide a partition that smoothly shifts in direction and also has a favorable straight-running property.

### Solution to Problem

In order to solve the foregoing problem, a partition according to the present invention is a partition including a pair of guide portions that are guided along a guide rail in an upper end portion of the partition; and a wheel configured for running on a floor surface in a center part of a lower end portion of the partition. According to the aforesaid feature of the present invention, the wheel is provided in the center part of the lower end portion of the partition, and brought into contact with the floor surface at one point. Thus, a direction shift of the partition is smoothly performed.

It may be preferable that the wheel has a double wheel structure in which two single wheels are attached to an axle shaft. According to this preferable configuration, a straight-running property of the partition becomes better.

It may be preferable that the partition further includes a frame member, and the double wheels are provided in a center part of a lower frame portion of the frame member. According to this preferable configuration, a weight of the partition can be reduced, and a load added to the floor surface via the wheel is reduced. Thus, the direction shift of the partition can be more smoothly performed.

It may be preferable that a distance between the two single wheels is slightly larger than a thickness of the frame member, and the axle shaft is positioned on the upper side of the lower frame portion. According to this preferable configuration, the lower frame portion of the partition can be inserted between the single wheels, and the axle shaft is positioned on the upper side of the lower frame portion. Thus, without changing a design of the main body of the partition, it is possible to improve a running property by making the single wheels of the double wheels have a large diameter.

It may be preferable that the two single wheels and the axle shaft and an attachment member of the axle shaft are assembled and unitized in advance, and then attached to an upper surface of the lower frame portion by the attachment member. According to this preferable configuration, it is possible to easily perform an attachment task and a replacement task of the wheel, etc.

### BRIEF DESCRIPTION OF DRAWINGS

FIG. 1 is a perspective view of a moving partition device that includes a partition of an embodiment of the present invention.

FIG. 2 is an enlarged vertically sectional view by the line A-A of FIG. 1.

FIG. 3 is an enlarged perspective view in which an A portion of FIG. 1 is seen from the obliquely lower side.

FIG. 4 is an enlarged perspective view in which a B portion of FIG. 1 is seen from the obliquely lower side.

FIG. 5 is a schematic plan view when similarly in the B portion of FIG. 1, a moving panel is moved to a guide rail on the opposite side, the guide rail that opposes across a support post so that the front and back sides are reversed.

FIG. 6 is an enlarged perspective view of a wheel in the embodiment.

FIG. 7 is an enlarged vertically sectional view by the line B-B of FIG. 6.

FIG. 8 is a sectional view by the line C-C of FIG. 7.

FIG. 9 is an enlarged vertically sectional view by the line D-D of FIG. 6.

### DESCRIPTION OF EMBODIMENTS

A mode for carrying out a partition of the present invention will be described below on the basis of an embodiment.

### Embodiment

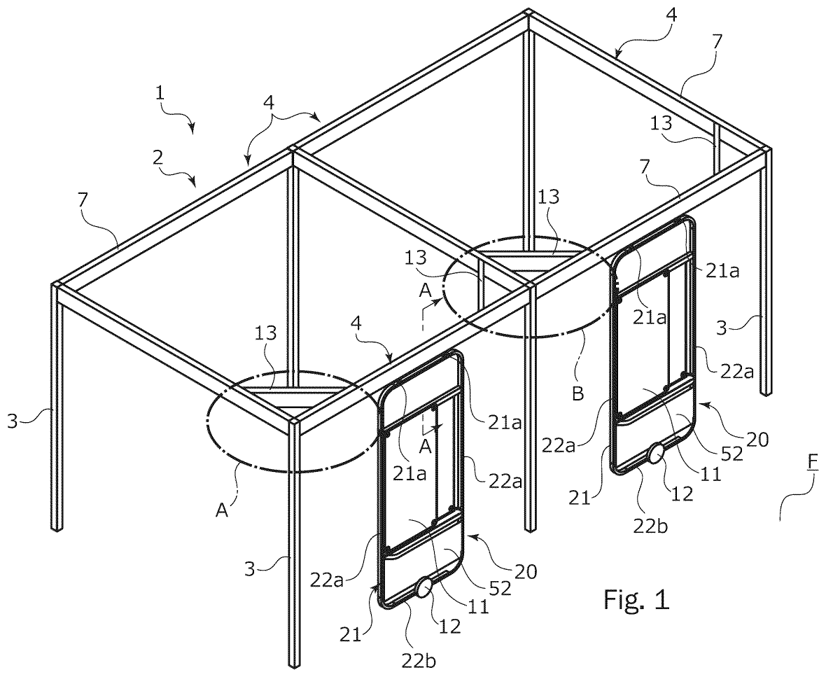

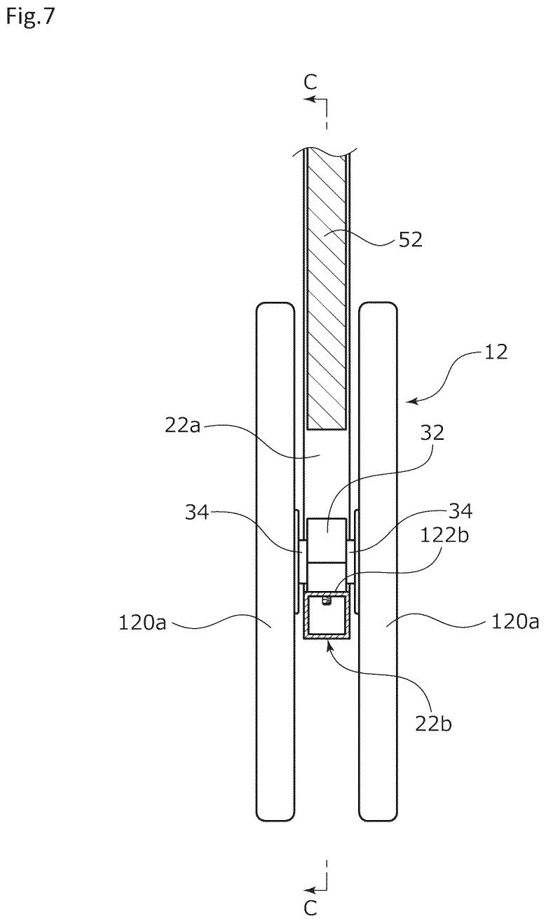

A partition according to an embodiment of the present invention will be described with reference to FIGS. 1 to 9. As illustrated in FIG. 1, partitions 20 of the present embodiment are used in a spatial structure 1 which is also a moving partition device.

As illustrated in FIG. 1, the spatial structure 1 of the present embodiment is installed to stand on its own on a floor surface F so that a large interior space such as an office and a showroom is partitioned into a square shape, and used for meetings, operation spaces, etc.

The spatial structure 1 includes a frame body 2 installed to stand on its own on the floor surface F. The frame body 2 includes six support posts 3 placed side by side at predetermined intervals on the front side, the rear side, the left side, and the right side with a vertical dimension which is lower than a ceiling surface, and seven beams 4 on the front side, the rear side, the left side, and the right side, the beams that couple upper end portions of the support posts 3 to each other at right angles so as to form a ladder frame shape in a plan view. The support posts 3 and the beams 4 are manufactured by extrusion molding of an aluminum material, etc., for example.

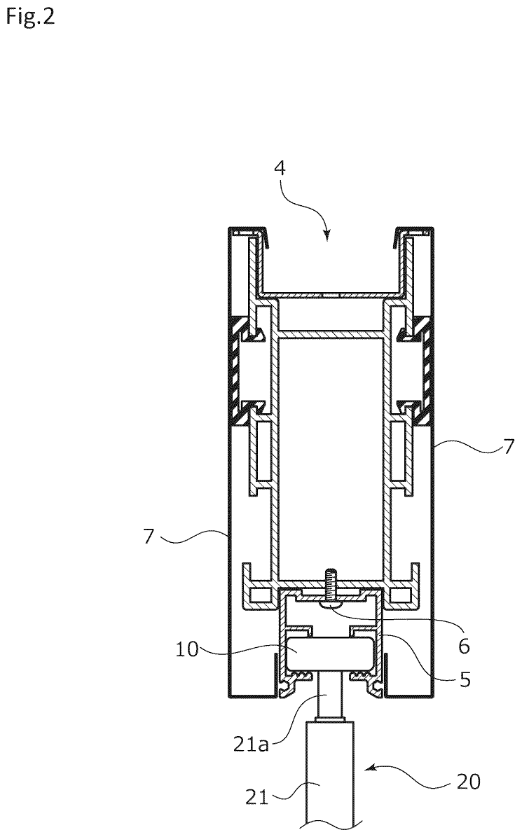

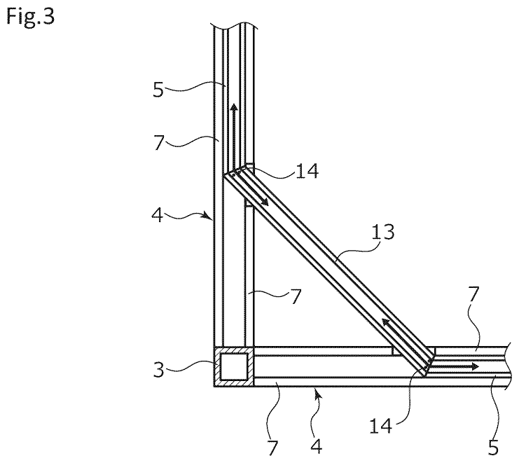

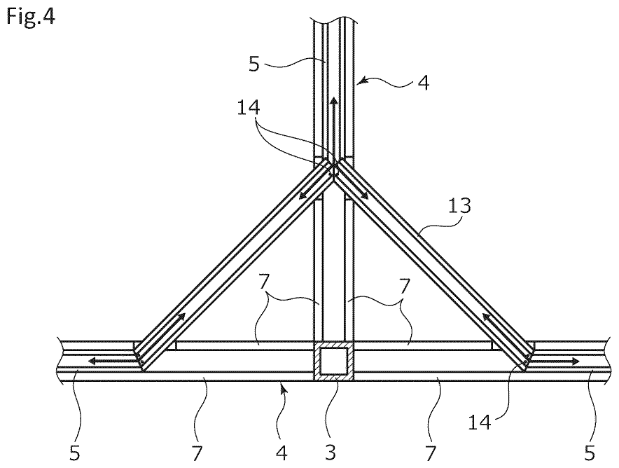

As illustrated in FIG. 2, to a downward recess-shaped lower surface formed in a lower end portion of each of the beams 4, a guide rail 5 whose lower ends are bent in an inwardly opposing form, the guide rail having a downward U-shaped cross section is fixed by a plurality of screws 6. The guide rail 5 is manufactured by extrusion molding of an aluminum material, etc., for example. Two guide rails 5 that extend in a right to left direction on the front side and three guide rails 5 that extend in the front to rear direction are formed to have a length that is shorter than an entire length of the beam 4 by a desired dimension so as to connect bridge rails 13 to be described later (see FIGS. 3 and 4). It is noted that both side surfaces of each beam 4 in the longitudinal direction are covered by cover members 7, 7 together with both side surfaces of the guide rail 5. However, it is also possible to omit such cover members 7.

As illustrated in FIG. 1, the partitions 20 are movably supported by the two guide rails 5, 5 that oppose each other across the support post 3 and extend in the right to left direction on the front side. That is, as illustrated in FIG. 2, lower ends of a pair of left and right support shafts 21a that are oriented in the up and down direction are secured to an upper surface of a frame member 21 of the partition 20, and by rollably fitting and inserting guide rollers 10 serving as guide portions that are freely-horizontally rotatably attached to upper end portions of both the support shafts 21a into the guide rail 5, the partition 20 is supported movably along the guide rail 5.

Also, to a central portion in the width direction of a lower surface of the frame member 21 of the partition 20, a wheel 12 that is rotated in contact with the floor surface F at the time of moving is attached. In such a way, the partition 20 is provided and extended from the floor surface F to the guide rail 5 on the upper side. The guide rollers 10 of both the support shafts 21a provided in an upper portion are guided to move by the guide rail 5, and the wheel 12 provided in a lower portion is provided rollably on the floor surface F. It is noted that although only two partitions 20 are illustrated in FIG. 1, three or more of plural partitions 20 may be provided.

In terminal ends of the guide rails 5, 5 in a corner portion on the front left side of the frame body 2 (A portion of FIG. 1), that is, the terminal ends in the crossing direction of the adjacent guide rails 5, 5 attached to the two beams 4, 4 that are connected to the support post 3 at right angles in a L shape from two directions, both ends of the linear bridge rail 13 having the same sectional shape as the guide rail 5 are built to make an angle of 45 degrees in a plan view and a bottom view and to continue to the guide rails 5, 5. Upper surfaces of both end portions of the bridge rail 13 are fixed to lower surfaces of the beams 4 by screws 14. Lower end portions of the adjacent cover members 7, 7 are cut out so that the bridge rail 13 is inserted. It is noted that the similar bridge rail 13 is also built over the guide rails 5 in a L shaped crossing portion on the right side.

Also, in terminal ends of the three guide rails 5 of a T shaped crossing portion in a central portion on the front side of the frame body 2 (B portion of FIG. 1), that is, the terminal ends in the crossing direction of the three adjacent guide rails 5 attached to the beams 4 that are connected to the support post 3 at right angles from three directions, both ends of the bridge rails 13, 13 that are similar to the above description are built to make an angle of 45 degrees in a plan view and a bottom view and to continue to the three guide rails 5.

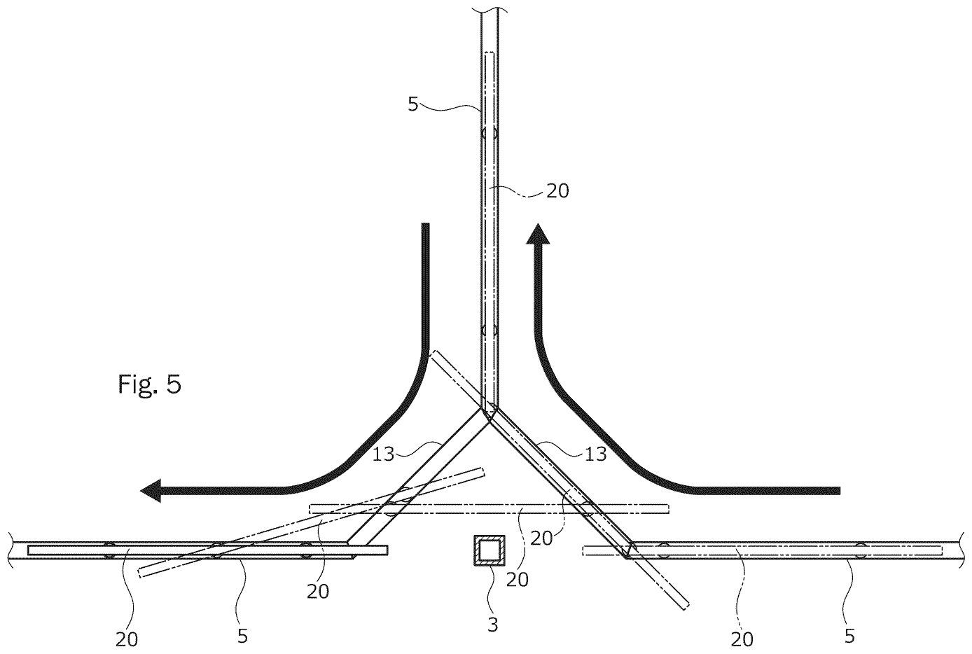

As illustrated in FIGS. 3 and 4, the bridge rails 13 are built over the guide rails 5 in the L shaped crossing portion and the T shaped crossing portion of the beams 4. Thus, the partition 20 can bypass the support post 3 and move from the beam 4 that is oriented in the right to left direction to the side of the beam 4 that is oriented in the front to rear direction via the bridge rail 13. Thereby, it is possible to change the partition 20 from the front side to the rear side and use a plate-shaped functional part to be described later. Also, as illustrated in FIG. 5, when the partition 20 on the right side is moved to the T shaped crossing portion side of the B portion of FIG. 1 and once moved to the side of the guide rail 5 that extends in the front to rear direction via the bridge rail 13 on the right side, and then switched back and moved to the opposing guide rail 5 side on the opposite side via the bridge rail 13 on the left side, it is possible to rotate the partition 20 by 180 degrees and make a front surface and a back surface reversed, and both surfaces of the plate-shaped functional part can be used.

Next, a configuration of the partition 20 will be described in detail. The partition 20 is mainly configured by the frame member 21, a felt screen (plate-shaped functional part) 11 provided in an upper portion in the frame member 21 and formed in a substantially rectangular shape in a front view, and a panel 52 provided in a lower portion of the frame member 21. The pair of guide rollers 10, 10 serving as the guide portions provided in an upper end portion of the frame member 21 to be separated from each other in the width direction are movable along the guide rail 5, and a load is supported by the floor surface F by the wheel 12 provided in a central portion in the width direction of a lower end portion of the frame member 21. The wheel 12 is rotated in contact with the floor surface F at the time of moving the partition 20. The frame member 21 and the felt screen (plate-shaped functional part) 11 provided in the frame member 21 and formed in a substantially rectangular shape in a front view configure a partition main body.

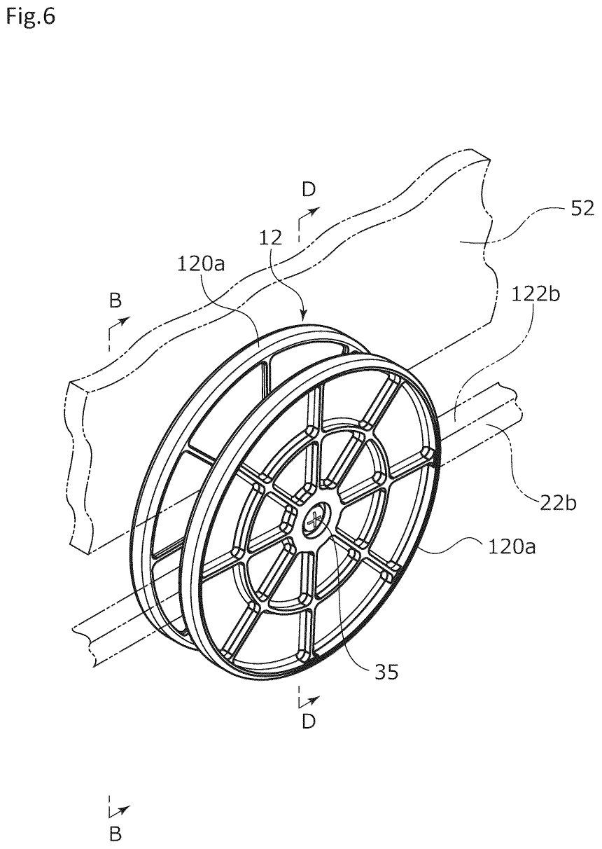

As illustrated in FIGS. 6 to 9, the wheel 12 described above has a double wheel structure in which two single wheels 120a, 120a are attached to both end portions of an axle shaft 31 that is oriented in the direction orthogonal to the moving direction of the partition main body (thickness direction of the partition main body). The wheel 12 is attached to an upper surface plate-shaped portion 122b of a lateral frame portion 22b that couples between lower portions of vertical frame portions 22a, 22a of the frame member 21 by an attachment member 32 (details will be described later). The single wheel 120a is formed of, for example, light metal such as synthetic resin and aluminum to have a relatively large diameter, and reinforced by providing and projecting a plurality of ribs on both side surfaces.

The wheel 12 is assembled in advance as follows. With reference to FIGS. 6 to 9, first, the axle shaft 31 having an enlarged diameter portion at one end is fitted and inserted into a stepped hole 120b in center of the single wheel 120a on one side from the outer side, and an intermediate portion of the axle shaft 31 is rotatably supported via a bearing (rolling bearing) 33 fitted to the attachment member 32 and a pair of cylindrical spacers 34, 34 on both the sides of the bearing 33.

Next, the other end portion of the axle shaft 31 is fitted and inserted into a stepped hole 120b of the single wheel 120a on the other side, and a screw 35 with a washer is screwed into a female screw hole (not illustrated) formed on an end surface of the axle shaft 31. Thereby, the two single wheels 120a, 120a, the axle shaft 31, the attachment member 32, and the pair of spacers 34 are integrally assembled and unitized. The single wheels 120a, 120a are rotated integrally with the axle shaft 31. Also, the single wheels 120a, 120a are assembled so that a distance between the single wheels is slightly larger than a thickness of the partition main body (an axial dimension of the axle shaft 31).

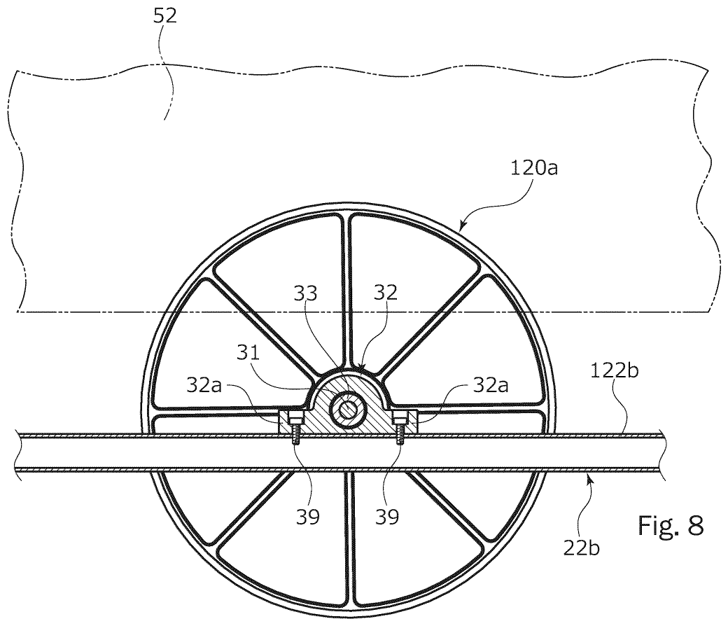

As illustrated in FIG. 8, by screwing hexagon socket screws 39, 39 inserted into attachment holes that are formed in a pair of fixing portions 32a, 32a of the attachment member 32 from the upper side into female screw holes (not illustrated) formed in a central portion in the width direction of the upper surface plate-shaped portion 122b of the lateral frame portion 22b, the wheel 12 is detachably fixed to an upper surface of a central portion of the lateral frame portion 22b so that the axle shaft 31 is positioned on the upper side of the lateral frame portion 22b.

As described above, in the partition 20 according to the embodiment, the wheel 12 is provided in a central portion of a lower end portion of the partition main body, and brought into contact with the floor surface F at one point. Thus, movement at the time of a direction shift of the partition 20 is smoothly performed.

In particular, when the partition 20 bypasses the support post 3 and moves from the beam 4 that is oriented in the right to left direction to the side of the beam 4 that is oriented in the front to rear direction via the bridge rail 13, the extending directions of the guide rail 5 of the beam 4 and the bridge rail 13 and the moving direction of the partition 20 are different from each other, and the wheel 12 is brought into sliding contact with the floor surface F. Thus, with a configuration that the wheel 12 is brought into contact with the floor surface F at one point, it is possible to reduce friction resistance and smoothly perform the direction shift. Also, even in a case where movement of reversing the partition 20 by 180 degrees is performed, it is possible to reduce the friction resistance and smoothly perform a reversing operation.

Also, the wheel 12 has the double wheel structure. Thus, a straight-running property at the time of moving the partition 20 along the guide rail 5 and the bridge rail 13 becomes favorable, and it is possible to continuously connect the plurality of partitions 20 in a linear form.

Further, the partition main body includes the hollow frame member 21 and the wheel 12 is provided in the central portion of the lateral frame portion 22b in the lower portion of this frame member 21. Thus, a weight of the partition main body can be reduced, and a load added to the floor surface F via the wheel 12 is reduced. Therefore, the direction shift of the partition 20 is more smoothly performed.

Further, the distance between the single wheels 120a, 120a is slightly larger than the thickness of the partition main body, and the axle shaft 31 is positioned on the upper side of the lateral frame portion 22b. Thus, the single wheels 120a, 120a do not interfere with the lower end portion of the partition main body. Therefore, without changing a design of the partition main body, it is possible to improve a running property by making the single wheels 120a have a large diameter.

Further, the two single wheels 120a, the axle shaft 31, the attachment member 32 of the axle shaft 31, and the pair of spacers 34 are assembled in advance and the wheel 12 is unitized, and the entire wheel 12 that includes the axle shaft 31 is attached to the upper surface plate-shaped portion 122b of the lateral frame portion 22b by the attachment member 32. Thus, it is possible to easily perform an attachment task and a replacement task of the wheel 12, etc.

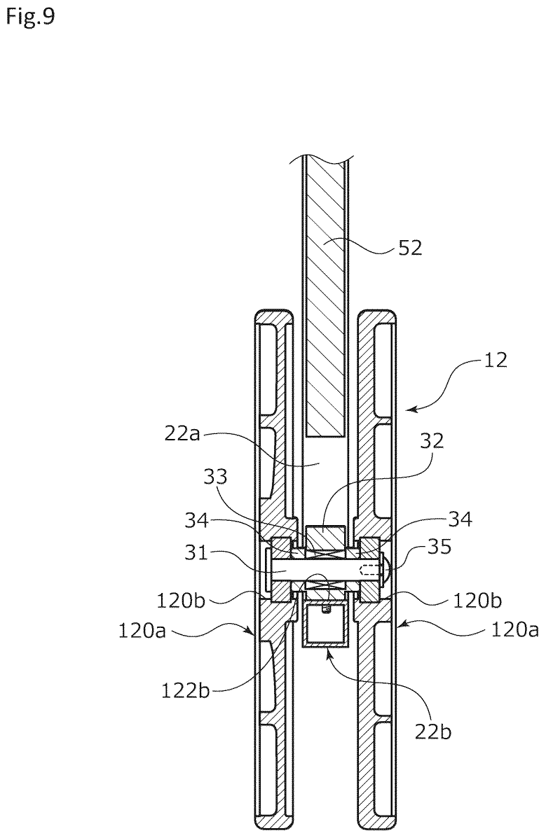

Also, as illustrated in FIG. 9, a lower end portion of the panel 52 provided in the lower portion of the frame member 21 is inserted into an upper half portion between the single wheels 120a, 120a. Thus, it is possible to produce a sense of unity in terms of outer appearance between the wheels 12 and the panel 52, and to also make the wheel 12 having a large diameter function as a compartment configuration of a space. Further, since a hand or a foot does not easily come in between the wheel 12 and the panel 52, it is possible to prevent injuries by being caught between the wheel and the panel.

Furthermore, the diameter of the wheel 12 has a length that is sufficiently larger than a height dimension of the lateral frame portion 22b, specifically, the length that is not less than three times more. Thereby, it is possible to make the partition 20 stably run by utilizing only one wheel 12.

Also, the wheel 12 has a large diameter. Specifically, the diameter is sufficiently longer than one tenth of a length dimension of the lateral frame portion 22b. Thereby, it is possible to make the partition 20 stably run by utilizing only one wheel 12.

The embodiment of the present invention is described above based on the drawings. However, specific configurations are not limited to the embodiment, and the present invention also includes additions and changes within the range not departing from the scope of the present invention.

For example, in the embodiment described above, the wheel 12 has the double wheel structure. However, the wheel 12 may be a single wheel. In this case, the single wheel may be provided in the lateral frame portion 22b.

Also, in the embodiment described above, the intermediate portion of the axle shaft 31 is supported by the bearing 33. However, regarding a lightweight partition 20 having a relatively small vertical dimension, the bearing 33 may be omitted, and the intermediate portion of the axle shaft 31 may be rotatably supported directly by the attachment member 32.

Further, in the embodiment described above, the single wheels 120a, 120a of the wheel 12 are rotated integrally with the axle shaft 31. However, both the single wheels 120a may be rotatably supported by both the end portions of the axle shaft via bearings (or without bearings).

### REFERENCE SIGNS LIST

1 Spatial structure
2 Frame body
3 Support post
4 Beam
5 Guide rail
10 Guide roller
12 Wheel
13 Bridge rail
20 Partition
21 Frame member
22b Lateral frame portion
31 Axle shaft
32 Attachment member
33 Bearing
34 Spacer
52 Panel
120a Single wheel
122b Lateral frame portion upper surface plate-shaped portion
F Floor surface

1. A partition, comprising:
a pair of guide portions that are guided along a guide rail in an upper end portion of the partition; and
a wheel configured for running on a floor surface in a center part of a lower end portion of the partition.

2. The partition according to claim 1,
wherein the wheel has a double wheel structure in which two single wheels are attached to an axle shaft.

3. The partition according to claim 2, further comprising a frame member,
wherein the double wheels are provided in a center part of a lower frame portion of the frame member.

4. The partition according to claim 3,
wherein a distance between the two single wheels is slightly larger than a thickness of the frame member, and the axle shaft is positioned on the upper side of the lower frame portion.

5. The partition according to claim 4,
wherein the two single wheels and the axle shaft and an attachment member of the axle shaft are preassembled as a unit and the preassembled unit is attached to an upper surface of the lower frame portion by the attachment member.
